(19) United States
(12) Patent Application Publication
(10) Pub. No.: US 2014/0099003 A1
(43) Pub. Date: Apr. 10, 2014

(54) METHODS OF MAINTAINING THE RELATIVE POSITION BETWEEN A DATA CAPTURE DEVICE AND AN OPERATOR OF THE DEVICE

(71) Applicants: Richard Jay Langley, Vienna, VA (US); Christopher Eric Holland, Fairfax, VA (US)

(72) Inventors: Richard Jay Langley, Vienna, VA (US); Christopher Eric Holland, Fairfax, VA (US)

(21) Appl. No.: 13/647,420

(22) Filed: Oct. 9, 2012

(51) Int. Cl. G06K 9/78

(52) U.S. Cl. 382/115

(57) ABSTRACT

A method for maintaining the relative position between a data capture device and an operator of the data capture device includes prompting the operator to arrange a data capture device to be in an optimal position relative to an operator of the device. Moreover, the method includes capturing authentication data of the operator with the data capture device while the operator uses data displayed on a screen of the data capture device, and determining whether the data capture device is in the optimal position relative to the operator while capturing authentication data of the operator. Furthermore, the method includes determining a displacement of the data capture device relative to the optimal position when the data capture device is in a position different than the optimal position, and shifting the data relative to the screen by applying the relative displacement to the data.

### BACKGROUND OF THE INVENTION

This invention relates generally to capturing data, and more particularly, to methods of maintaining the relative position between a data capture device and an operator of the data capture device while capturing data from an operator of the device.

Authentication data capture devices such as smart devices and personal computers (PC) equipped with web cameras (web cams) may be used to capture authentication data. Smart devices generally include smart phones and tablet computers. Smart devices and PCs equipped with web cams are used because they are ubiquitous and easily operated to capture many different types of authentication data. For example, operators may type or speak their personal identification number (PIN) into a smart device or PC. Moreover, smart devices and PCs equipped with web cams may capture photographs or video images of operators for use as face biometric data during authentication transactions. Furthermore, smart devices and PCs equipped with web cams may capture a photograph or video image of an operator as the operator recites his PIN or other such identifying information to simultaneously capture different types of authentication data. Authentication data remotely captured with smart devices and PCs is typically sent to an authentication system which conducts an authentication transaction. If the operator is successfully authenticated he is permitted to conduct a desired transaction; otherwise, not.

However, while capturing face biometric data in the form of a photograph or video image operators have been known to become distracted and inadvertently move the smart device, or move themselves within the range of a web cam, such that a partial image of their face is captured. Such incomplete images generally cannot be processed and used to generate trustworthy authentication transaction results. It has been known to display messages instructing operators to maintain the relative position between an authentication data capture device and the operator. However, such messages generally do not facilitate maintaining the relative position and thus capturing complete images because glare on the display may prevent an operator from reading it, or because the same distractions may still prevent the operator from maintaining the relative position between the authentication data capture device and the operator. Generally, unless operators focus solely on maintaining the correct relative position, the positioning drifts. For example, when multiple types of authentication data are simultaneously captured from an operator, or during continuous verification, operators typically do not focus on maintaining the correct relative position. As a result, poor authentication data is captured and poor results are generated.

### BRIEF DESCRIPTION OF THE INVENTION

In one aspect, a method for maintaining the relative position between a data capture device and an operator of the data capture device is provided that includes prompting the operator to arrange a data capture device to be in an optimal position relative to an operator of the device. The optimal position is a position of the data capture device in which acceptable authentication data of the operator is captured. Moreover, the method includes capturing authentication data of the operator with the data capture device while the operator uses data displayed on a screen of the data capture device, and determining whether the data capture device is in the optimal position relative to the operator while capturing authentication data of the operator. Furthermore, the method includes determining a displacement of the data capture device relative to the optimal position when the data capture device is in a position different than the optimal position, and shifting the data relative to the screen by applying the relative displacement to the data to provide a visual cue to the operator that unacceptable authentication data is being captured and encourage the operator to move the data capture device into the optimal position.

In another aspect, an apparatus for capturing authentication data is provided. The apparatus includes a processor, a memory, at least one camera, and a screen. The apparatus is configured to capture authentication data from an operator while the operator monitors the position of data displayed on the screen, and to shift the position of the displayed data relative to the screen in the same manner as a position of captured authentication data changes relative to the field of view of the at least one camera.

In yet another aspect, a computer program recorded on a non-transitory computer-readable recording medium is provided. The computer program is included in a data capture device and is for maintaining a relative position between the data capture device and an operator. Moreover, the computer program includes instructions, which when read and executed by the data capture device, cause the data capture device to capture authentication data from an operator while the operator monitors the position of data displayed on a screen of the data capture device. Moreover, the computer program causes the data capture device to change the position of the data relative to the screen in the same manner as a position of captured authentication data changes relative to a field of view of the device.

### BRIEF DESCRIPTION OF THE DRAWINGS

FIG. 1 is a side view of an operator capturing authentication data from himself with an exemplary data capture (DC) device;

FIG. 2 is an enlarged plan view of the exemplary DC device shown in FIG. 1;

FIG. 3 is an enlarged plan view of the exemplary DC device shown in FIG. 2, displaying data on a screen of the DC device;

FIG. 4 is a plan view of the exemplary DC device shown in FIG. 3 displaying partial data on the screen as a result of rotating the DC device about the X-axis;

FIG. 5 is a plan view of the exemplary DC device shown in FIG. 3 displaying partial data on the screen as a result of rotating the DC device about the Y-axis;

FIG. 6 is a plan view of the exemplary DC device shown in FIG. 3 displaying partial data on the screen as a result of rotating the DC device about the X and Y-axes;

FIG. 7 is a plan view of the exemplary DC device displaying partial data on the screen as shown in FIG. 6 as a result of rotating the DC device about the X and Y-axes and translating the DC device away from an operator;

FIG. 8 is a plan view of the exemplary DC device shown in FIG. 3 displaying partial data on the screen as a result of translating the DC device towards the operator; and

FIG. 9 is a flowchart illustrating an exemplary method of maintaining a relative position between the DC device and an operator of the DC device.

### DETAILED DESCRIPTION OF THE INVENTION

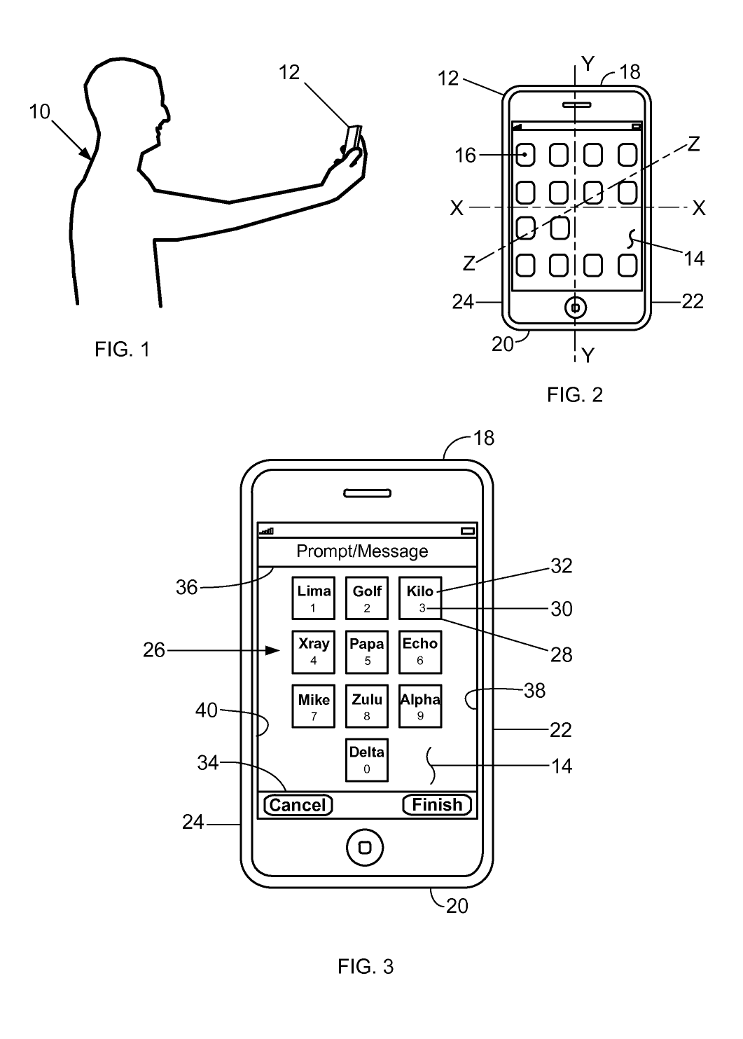

FIG. 1 is a side view of an operator 10 capturing authentication data of himself with an exemplary data capture (DC) device 12 while using data displayed on the DC device 12. Specifically, the DC device 12 and the operator are positioned relative to each other such that the operator 10 may use data displayed on the DC device 12 while the DC device 12 captures authentication data of the operator. The DC device 12 is associated with at least one operator who operates the DC device 12 and is also the individual offering authentication data for capture.

FIG. 2 is an enlarged plan view of the exemplary DC device 12 shown in FIG. 1. More specifically, the exemplary DC device 12 is a smart phone that stores applications and data therein, and displays at least one of text and images. The applications cause the DC device 12 to perform at least the functions described herein. The DC device 12 includes a display screen 14 such as, but not limited to, a Liquid Crystal Display (LCD) that displays at least one of text and images. Moreover, the DC device 12 may include buttons and icons 16 for at least entering commands and invoking applications stored therein. Furthermore, the DC device 12 may include multiple cameras (not shown) and microphones (not shown). Each different camera included in the DC device 12 has a different field of view. Thus, the DC device 12 may have several different fields of view and may capture images of the same or different objects within each different field of view. Consequently, the DC device 12 may simultaneously capture photographs and video images of objects that are positioned within the different fields of view.

Although the exemplary DC device 12 is a smart phone, the DC device 12 may alternatively be any device capable of at least storing data, displaying at least one of text and images, and capturing and transmitting data. Such other devices may be portable or stationary and include, but are not limited to, a cellular phone, a tablet computer, a laptop computer, a personal computer (PC) equipped with a web camera (web cam), any type of device having wireless capabilities such as a personal digital assistant (PDA), entertainment devices, and gaming consoles. Entertainment devices include, but are not limited to, televisions. Gaming consoles include, but are not limited to, Xbox 360 and Nintendo Wii.

The DC device 12 includes a top end 18, a bottom end 20, a right side 22, and a left side 24. Moreover, a three-dimensional Cartesian coordinate system having X, Y, and Z-axes is associated with the DC device 12. The origin of the Cartesian coordinate system is positioned on, and is positioned coincident with a center of, the screen 14. Alternatively, the origin may be positioned such that the X, Y and Z-axes are coincident with respective sides of the DC device 12, or such that the origin is positioned in any fixed location relative to the DC device 12. The X, Y and Z-axes represent axes that the device 12 may rotate about and translate along. Thus, the DC device 12 may be rotated clockwise and counterclockwise about any one of the X, Y, and Z-axes, and any combination of these axes. Moreover, the DC device 12 may be translated along any one of the X, Y, or Z-axes, and may be simultaneously translated along any combination of the X, Y, and Z-axes. Furthermore, the DC device 12 may be simultaneously rotated about and translated along any combination of the X, Y, and Z-axes.

Rotating counterclockwise about the X-axis is considered rotating the top end 18 of the device 12 away from the operator, while rotating clockwise about the X-axis is considered rotating the top end 18 of the device 12 towards the operator. Rotating counterclockwise about the Y-axis is considered rotating the right side 22 of the DC device 12 towards the operator, while rotating clockwise about the Y-axis is considered rotating the left side 24 towards the operator. Translating along the Z-axis moves the device 12 towards or away from the operator.

The DC device 12 may be configured to communicate with other systems (not shown) and other devices (not shown) over a communications network. The communications network may be any wireless network including, but not limited to, 4G, 3G, Wi-Fi, Global System for Mobile (GSM), and Enhanced Data for GSM Evolution (EDGE) and any combination of a local area network (LAN), a wide area network (WAN) and the Internet. Other systems (not shown) and devices (not shown) that the DC device 12 may communicate with include other DC devices, authentication computer systems, and computer systems of service providers such as, but not limited to, financial institutions, medical facilities, national security agencies, and merchants.

The DC device 12 may be used to capture any type of data including, but not limited to, authentication data. Authentication data may be any kind of information that may be used to authenticate operators such as, but not limited to, secret authentication data of operators, Global Positioning System (GPS) coordinates, biometric authentication data of operators, and any combination thereof. Secret authentication data includes, but is not limited to, pass-phrases, personal identification numbers (PIN), and knowledge-based answers to queries. Biometric authentication data may correspond to any biometric characteristic desired to be used as a basis of authentication such as, but not limited to, voice, face, finger, iris, palm, feet, and electrocardiogram, and any combination of voice, face, finger, iris, palm, feet, and electrocardiogram. Biometric authentication data may take any form including, but not limited to, audio recordings, photographs, and video streams.

The DC device 12 may also transmit captured authentication data to an authentication computer system. Furthermore, the DC device 12 may process captured authentication data prior to transmitting it to the authentication computer system. For example, the DC device 12 may create a biometric template from captured biometric data and then transmit the biometric template to the authentication computer system.

The DC device 12 includes a processor (not shown) and a memory (not shown). It should be understood that, as used herein, the term processor is not limited to just those integrated circuits referred to in the art as a processor, but broadly refers to a computer, an application specific integrated circuit, and any other programmable circuit. It should be understood that the processor executes instructions, or computer programs, stored in the memory. The above examples are exemplary only, and are thus not intended to limit in any way the definition and/or meaning of the term “processor.”

The memory (not shown) in the DC device 12 can be implemented using any appropriate combination of alterable, volatile or non-volatile memory or non-alterable, or fixed, memory. The alterable memory, whether volatile or non-volatile, can be implemented using any one or more of static or dynamic RAM (Random Access Memory), flash memory or the like. Similarly, the non-alterable or fixed memory can be implemented using any one or more of ROM (Read-Only Memory), PROM (Programmable Read-Only Memory), EPROM (Erasable Programmable Read-Only Memory), and EEPROM (Electrically Erasable Programmable Read-Only Memory).

The memory (not shown) can be a computer-readable recording medium used to store data in the DC device 12. Data generated by the DC device 12 may also be stored in the memory (not shown). Moreover, the memory (not shown) can be a computer-readable recording medium used to store computer programs or executable instructions that are executed by the DC device 12. Furthermore, the memories (not shown) may include smart cards, SIMs or any other medium from which a computing device can read data, computer programs or executable instructions. As used herein, the term “computer program” is intended to encompass an executable program that exists permanently or temporarily on any computer-readable recordable medium that causes the computer or computer processor to execute the program and thus causes the computer to perform a function. Applications as described herein are computer programs.

FIG. 3 is an enlarged plan view of the exemplary DC device 12 shown in FIG. 2 further including data 26 displayed on the screen 14. The data 26 is a keypad. However, any data 26 may alternatively be displayed on the screen 14 that may be used to facilitate maintaining the position of the DC device 12 relative to an operator. Such data includes, but is not limited to, a keypad, a book, a list of answers with corresponding text-strings, electronic documents and articles downloaded over a network, and photographs. Moreover, the data 26 may be the same as or different than the authentication data captured of the operator. Examples of using such data 26 include, but are not limited to, reciting information included in a keypad displayed on the screen 14, reading the text of a book displayed on the screen 14, and entering alphanumeric data into a form displayed on the screen 14.

The keypad includes ten keys 28 that are each associated with different key data 30. The key data 30 includes numbers from 0 to 9. Alternatively, the key data 30 may include any numbers, letters, or any combination of numbers and letters. Each key 28 is also associated with a different exemplary text-string 32. Thus, each item of key data 30 is associated with a different exemplary text-string 32. Specifically, the exemplary text-strings “Lima,” “Golf,” “Kilo,” “Xray,” “Papa,” “Echo,” “Mike,” “Zulu,” “Alpha,” and “Delta” are associated with the key data 30 numbers 1-9 and 0, respectively. Each item of key data 30 corresponds to a character in an operator's PIN. Each text-string 32 may include any number of alphabetic characters. Thus, many different text-strings may be used. For example, text-strings may be used that include a lone alphabetic character, a group of alphabetic characters, words formed from groups of alphabetic characters, and phrases and sentences formed from words. The words may be of any length and have any number of syllables. The text-strings 32 corresponding to the characters of an operator's PIN may be recited during authentication transactions. For example, for the PIN 1859, the operator recites the corresponding text-strings “Lima,” “Zulu,” “Papa,” and “Alpha” during authentication.

The position of the data 26 is shifted, or moved, towards a bottom end 34 of the screen 14 when the DC device 12 is rotated counterclockwise about the X-axis, and is shifted, or moved, towards a top end 36 of the screen 14 when the DC device 12 is rotated clockwise about the X-axis. Similarly, the position of the data 26 is moved towards a right side 38 of the screen 14 when the DC device 12 is rotated counterclockwise about the Y-axis, and is moved towards a left side 40 of the screen 14 when the DC device 12 is rotated clockwise about the Y-axis. As the DC device 12 is translated along the Z-axis, the image of the data 26 changes size relative to the screen 14. More specifically, as the DC device 12 is translated away from the operator the size of the data 26 displayed on the screen 14 becomes smaller, and as the DC device 12 is translated towards the operator the size of the data 26 displayed on the screen 14 becomes larger.

The DC device 12 is in an optimal position when arranged to face the operator and capture a complete facial image of the operator while he uses the displayed data 26. For example, the DC device 12 is in an optimal position when it captures a complete facial video image of the operator reciting or typing his PIN into the DC device 12, or silently reading the data 26 from the DC device 12. Captured recitations of the operator's PIN may be used to authenticate the operator based on his PIN and voice biometric data, while captured video images may also be used to authenticate the operator based on biometric data. Moreover, captured video images may be used to facilitate determining liveness of the operator by determining whether mouth movements included in captured video images are synchronized with text recited by the operator or voice biometric data captured of the operator. Checking between multiple types of data captured simultaneously is a powerful form of liveness detection as it is difficult to spoof multiple modalities of authentication data captured simultaneously.

The optimal position is a position of the DC device 12 relative to the operator that enables the operator to easily use the data 26 while simultaneously capturing acceptable authentication data with the DC device 12. Acceptable authentication data is authentication data that may be used to generate trustworthy transaction results. The DC device 12 may continuously capture authentication data in the form of a facial video image of the operator while the operator uses the data 26.

When the DC device 12 is not in the optimal position relative to the operator when capturing authentication data of the operator, the captured authentication data is not acceptable authentication data. For example, authentication data in the form of a facial video image captured while the device 12 is in a position relative to the operator other than the optimal position is unacceptable authentication data. Conversely, a facial video image captured while the DC device 12 is in the optimal position relative to the operator is acceptable authentication data. The DC device 12 may alternatively capture authentication data in the form of still photographs of the operator while using the data 26. More than one type of authentication data may be simultaneously captured from an operator. For example, an operator's PIN, voice biometric data, and face biometric data may be simultaneously captured by the DC device 12. However, if the DC device 12 is not in the optimal position relative to the operator while capturing the authentication data, acceptable face biometric data will not be captured and the operator will not be successfully authenticated. As a result, as described herein, the operator is prompted by a visual cue to reorient the DC device to capture authentication data so he can be successfully authenticated.

The image of the operator moves with respect to the field of view of the DC device 12 by an amount proportional to a displacement of the DC device 12 relative to the optimal position. Incomplete or partial data 26 displayed on the screen 14 indicates that unacceptable authentication data is being captured.

When incomplete facial image data of the operator is within the DC device's field of view, a current position of the DC device 12 relative to the operator is determined. The current position is different than the optimal position. More specifically, the DC device 12 determines the displacement of the DC device 12 in the current position relative to the optimal position. The relative displacement may be a rotational displacement, a translational displacement, or a combination of rotational and translational displacements about and along any combination of the X, Y, and Z-axes. The DC device 12 applies the determined relative displacement to the data 26 and thus causes the displayed data 26 to shift on the screen 14 by an amount proportional to the determined relative displacement. Thus, as the DC device 12 moves relative to the optimal position, the displayed data 26 shifts relative to the screen 14 by an amount proportional to the displacement of the DC device 12 relative to the optimal position. As a result, the displayed data 26 shifts, or moves, relative to the screen 14 in the same manner as the image of the operator moves relative to the field of view of the DC device 12. The difference between the current and optimal positions is manifested to the operator by shifting the position of the displayed data 26 relative to the screen 14. Thus, it should be understood that the displayed data 26 shift on the screen 14 mimics the movement of the operator's image relative to the DC device's field of view.

By virtue of shifting or moving the displayed data 26 relative to the screen 14, the shifted displayed data 26 functions as a visual cue to the operator that the DC device 12 is not in the optimal position, and thus encourages the operator to move the DC device 12 back to a position substantially the same as the optimal position which results in optimally displaying the data 26 on the screen 14 and capturing acceptable authentication data.

When an operator realizes that incomplete or partial data 26 is displayed, the operator repositions the DC device 12 from the current position to the optimal position by rotating and/or translating it, as appropriate, about or along any combination of the X, Y, and Z-axes that causes the entire data 26 to appear on the screen 14. The position of the displayed data 26 on the screen 14 indicates how the DC device 12 should be repositioned. For example, when the displayed data 26 is at the bottom 34 of the screen 14, the DC device 12 should be rotated clockwise about the X-axis to shift the displayed data 26 within the screen 14 until all of the data 26 is displayed. Thus, by virtue of viewing the position of the displayed data 26 relative to the screen 14, operators understand that the DC device 12 is to be repositioned into the optimal position, and understand the movement required to reposition the DC device 12 substantially into the optimal position.

As the DC device 12 is repositioned, the relative displacement of the DC device 12 with respect to the optimal position changes and becomes smaller. The DC device applies the changed relative displacement to the data 26 such that more of the data 26 appears on the screen 14 until all of the data 26 appears on the screen 14. Moreover, as the relative displacement changes and becomes smaller, more of the operator's image appears within the field of view of the DC device 12 until the complete image of the operator's face is within the field of view. Thus, while repositioning the DC device 12, the position of the displayed data 26 relative to the screen 14 also changes in the same manner as the captured image of the operator changes relative to the field of view of the DC device. Operators monitor the position of the displayed data 26 in the screen 14 until the entire data 26 is displayed on the screen 14, which is a natural reaction because the operator should see all the data 26 in order to properly use the data 26.

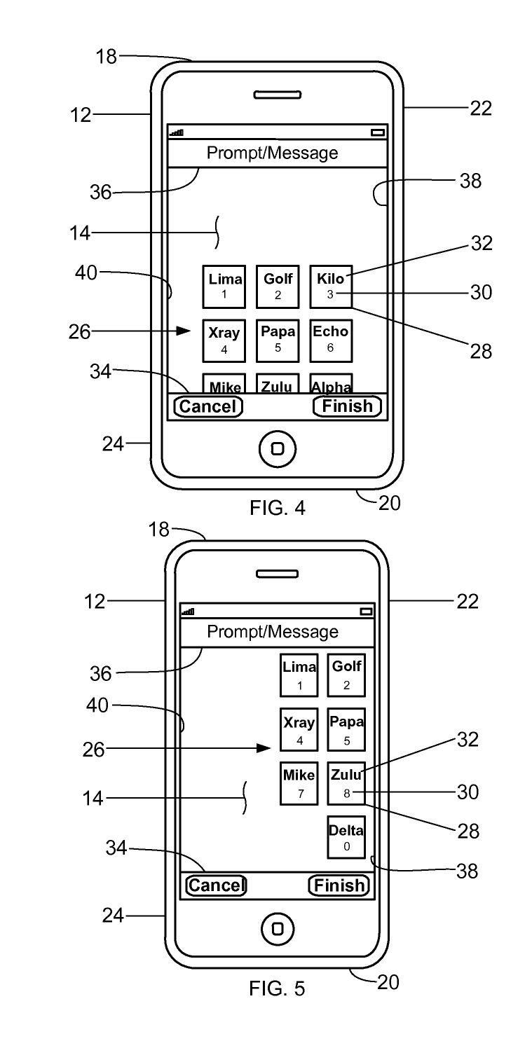

The information shown in FIGS. 4-8 is the same information shown in FIG. 3 as described in more detail below. As such, features illustrated in FIGS. 4-8 that are identical to features illustrated in FIG. 3, are identified using the same reference numerals used in FIG. 3.

FIG. 4 is a plan view of the DC device 12 shown in FIG. 3 displaying incomplete or partial data 26 on the screen 14 as a result of rotating the DC device 12 counterclockwise about the X-axis. More specifically, the displayed data 26 is positioned towards the bottom end 34 of the screen 14. The DC device 12 should be rotated clockwise about the X-axis to be repositioned substantially into the optimal position. As the DC device 12 is rotated about the X-axis, more of the data 26 is displayed on the screen 14 until all of the data 26 is displayed.

FIG. 5 is a plan view of the DC device 12 shown in FIG. 3 displaying incomplete or partial data 26 on the screen 14 as a result of rotating the DC device 12 counterclockwise about the Y-axis. More specifically, the displayed data 26 is positioned towards the right side 38 of the screen 14. The DC device 12 should be rotated clockwise about the Y-axis to be repositioned substantially into the optimal position. As the DC device 12 is rotated about the Y-axis, more of the data 26 is displayed on the screen 14 until all of the data 26 is displayed.

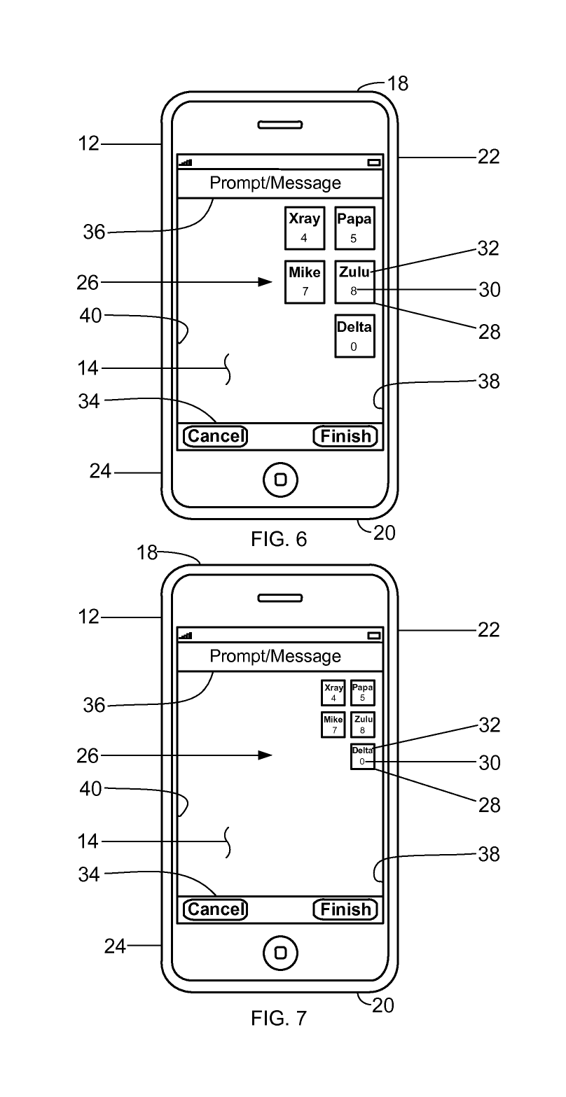

FIG. 6 is a plan view of the DC device 12 shown in FIG. 3 displaying incomplete or partial data 26 on the screen 14 as a result of rotating the DC device 12 clockwise about the X-axis and counterclockwise about the Y-axes while capturing face biometric data. More specifically, the displayed data 26 is positioned towards a corner of the screen 14 where the top end 36 and the right side 38 meet. The DC device 12 should be rotated counterclockwise about the X-axis and clockwise about the Y-axis to be repositioned substantially into the optimal position. As the DC device 12 is rotated, more of the data 26 is displayed on the screen 14 until all of the data 26 is displayed.

FIG. 7 is a plan view of the DC device 12 displaying incomplete or partial data 26 on the screen 14 as shown in FIG. 6. However, the DC device 12 has also been translated along the Z-axis away from the operator. As a result, the data 26 as displayed on the screen 14 is substantially smaller. The DC device 12 should be rotated counterclockwise about the X-axis, rotated clockwise about the Y-axis, and translated towards the operator along the Z-axis to be repositioned substantially into the optimal position. As the DC device 12 is rotated and translated into the optimal position, more of the data 26 is displayed on the screen 14 until all of the data 26 is displayed.

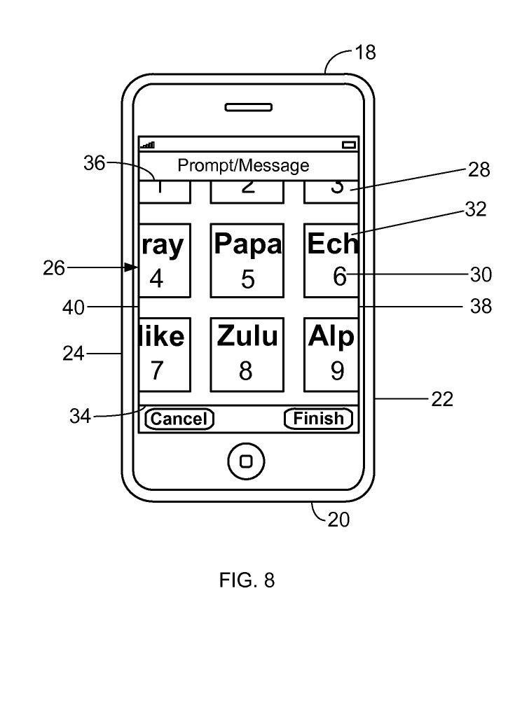

FIG. 8 is a plan view of the DC device 12 shown in FIG. 3 displaying incomplete or partial data 26 on the screen 14 as a result of translating the DC device 12 along the Z-axis towards the operator. The data 26 as displayed on the screen 14 is substantially larger than that shown in FIG. 3 such that the entire data 26 does not fit within the screen 14. The DC device 12 should be translated away from the operator along the Z-axis to be repositioned substantially into the optimal position. As the DC device 12 is translated away from the operator, the displayed data 26 becomes smaller such that more of the data 26 appears on the screen 14 until all of the data 26 is displayed.

Because the displayed data 26 shifts or moves relative to the screen 14 in proportion to the relative displacement, when there is a large relative displacement the data 26 may shift relative to the screen 14 such that none of the data 26 is displayed thereon. When an operator realizes that none of the data 26 is displayed, the operator repositions the DC device 12 from the current position until the facial image of the operator appears in the DC device's field of view such that at least some of the data 26 is displayed on the screen 14. The operator should then continue to move the DC device 12 substantially into the optimal position. Alternatively, when there is a large relative displacement, the displayed data 26 may not shift or move completely off the screen 14. In such alternative processes, the displayed data 26 is shifted or moved relative to the screen 14 in proportion to the relative displacement until a small part of the data 26 is displayed on the screen 14. A small part of the data 26 may be a percentage of the entire data 26 displayed on the screen 14, for example, ten percent. The small part of the data 26 may alternatively be determined in any manner.

Individuals are required to prove who they claim to be during authentication transactions conducted under many different circumstances. For example, individuals may be required to prove their identity to passport control during an authentication transaction conducted in person at an airport. Alternatively, individuals may be requested to prove their identity to a merchant while attempting to remotely purchase a product from a merchant system over the internet. Such individuals may operate their DC devices 12 to prove their identities.

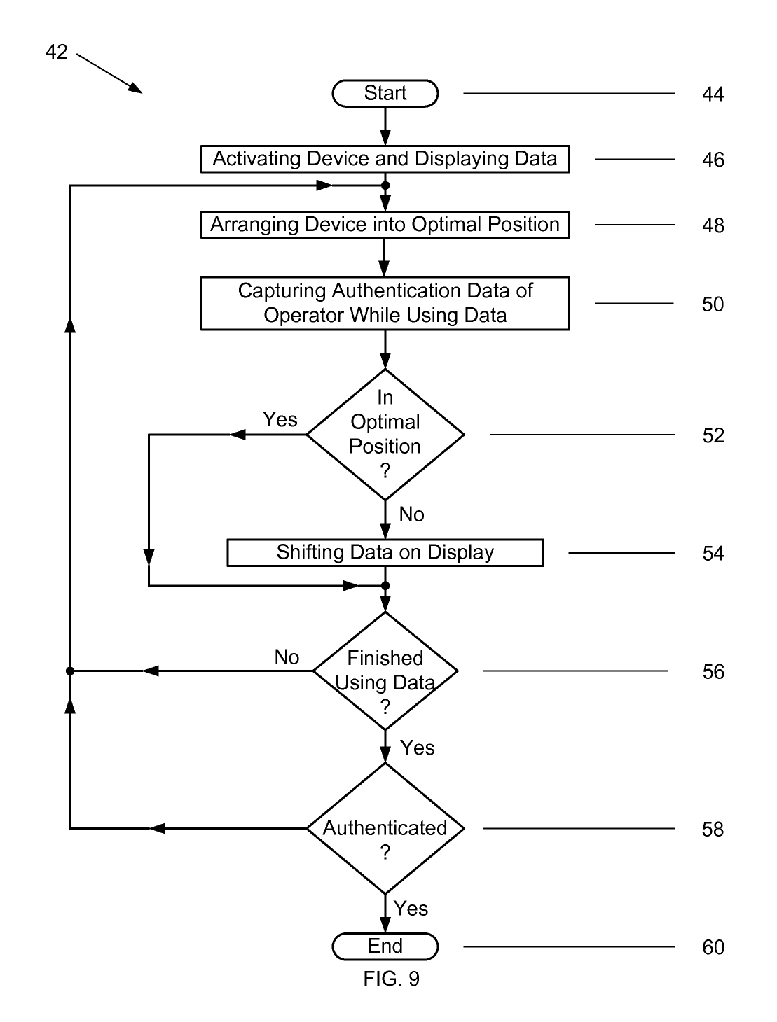

FIG. 9 is a flowchart 42 illustrating an exemplary method of maintaining a relative position between the DC device 12 and an operator using the displayed data 26, to thus maintain the DC device 12 in the optimal position while capturing authentication data of the operator. The process starts 44 with an operator activating 46 his DC device 12 and positioning the DC device 12 to fit at least a partial image of his face within the DC device's field of view. Next, the DC device 12 continues by identifying the operator's facial image relative to the field of view and displaying the data 26 relative to the screen 14 in the same manner as the operator's facial image is positioned relative to the DC device's field of view. A message is also displayed on the screen 14 prompting the operator to arrange the DC device 12 substantially into the optimal position. After reading the message from the screen 14, the operator continues by arranging 48 the DC device 12 substantially into the optimal position. The DC device 12 is a portable smart phone and the displayed data 26 is a keypad.

Next, the operator continues by capturing authentication data of himself 50 while using the displayed data 26. More specifically, the operator continues by reciting the text-strings 32 corresponding to the characters of his PIN while the DC device 12 captures the recitations and a facial video image of the operator. As a result, PIN, voice biometric data, and face biometric data of the operator are captured simultaneously by the DC device 12. Thus, the authentication data of the exemplary process is the PIN, voice biometric data, and face biometric data of the operator. Such captured authentication data may support rigorous multi-factor authentication transactions and provide more trustworthy transaction results compared with authentication transactions based on a single factor of authentication. In this exemplary process, the PIN of the operator is 1859 and the corresponding text-strings 32 are “Lima,” “Zulu,” “Papa,” and “Alpha.” The text-strings 32 are recited in the order the corresponding characters appear in the PIN. Thus, the operator recites “Lima,” “Zulu,” “Papa,” and “Alpha” during authentication.

While capturing authentication data of himself 50, the operator may become distracted and inadvertently move the DC device 12 out of the optimal position. Consequently, the DC device 12 determines 52 its position relative to the optimal position 52 at least while the operator captures authentication data. Thus, while capturing authentication data, the DC device 12 also determines whether it is in the optimal position 52. More specifically, the DC device 12 determines whether a complete facial image of the operator is within the field of view of the DC device 12.

When the facial image of the operator has shifted relative to the field of view of the DC device 12 such that the facial image is not completely within the field of view, it is determined that the DC device 12 is not in the optimal position and processing continues by shifting 54 the displayed data 26 relative to the screen 14. More specifically, the DC device 12 continues by determining the displacement of the current position of the DC device relative to the optimal position, and applying the determined relative displacement to the displayed data 26. Doing so causes the displayed data 26 to shift relative to the screen 14 by an amount proportional to the determined relative displacement.

After noticing that the displayed data 26 has shifted relative to the screen 14 such that partial data 26 is displayed, the operator moves the DC device 12 from the current position substantially into the optimal position. While the DC device 12 is moved into the optimal position, the DC device 12 continues by applying the changed relative displacement to the data 26 which causes the displayed data 26 to shift 54 on the screen 14 until the entire data 26 appears on the screen 14. After shifting 54 the displayed data 26 such that all of the data 26 is displayed on the screen 14, the DC device 12 continues processing by determining whether the operator is finished 56 using the displayed data 26. That is, whether the operator has finished reciting the text-strings 32. If so, processing continues by authenticating 58 the operator. More specifically, the captured PIN, voice biometric data, and facial image biometric data are compared against the corresponding data of the operator stored in an authentication system. When the captured and stored biometric data match, the operator is successfully authenticated 58. Next, processing ends 60. Otherwise, the operator is not successfully authenticated 58, and processing continues by arranging the DC device 12 substantially into the optimal position 48 and capturing authentication data of the operator 50.

However, when the operator is not finished using the data 56, processing continues by arranging the DC device 12 substantially into the optimal position 48 and capturing 50 authentication data of the operator. When it is determined that a complete facial image of the operator is within the field of view, the DC device 12 is determined to be in the optimal position 52. Thus, processing continues by determining whether the operator is finished 56 using the displayed data 26. If so, processing continues by authenticating 58 the operator as described herein. Otherwise, when the operator is not finished 56, processing continues by arranging the DC device 12 substantially into the optimal position 48 and capturing authentication data of the operator 50.

In the exemplary process, the DC device 12 determines that the operator is finished 56 using the displayed data 26 when the DC device 12 determines that the operator has finished reciting, or speaking, the text-strings 32 corresponding to the characters of his PIN. However, in alternative processes the DC device 12 may determine that the operator is finished 56 in any manner including, but not limited to, determining that the operator activated a button or icon 16 indicating he is finished.

While capturing authentication data with the DC device 12, the DC device 12 may experience many small relative displacements that do not materially affect the position of the displayed data 26 with respect to the screen 14. However, repeatedly displacing the DC device 12 by small angles and/or translations may cause the displayed data 26 to repeatedly shake with respect to the screen 14, or to change size with respect to the screen 14. Small angles are generally less than five degrees and small translations are generally less than a foot. Alternatively, small angles may be any angle that keeps desired elements of the operator's face within the device's field of view.

Although the displayed data 26 shifts, or moves, with respect to the screen 14 by an amount proportional to the relative displacement of the DC device 12 in the exemplary process, in alternative processes the displayed data 26 may not move with respect to the screen 14 until the DC device 12 moves through a minimum relative displacement. For example, the minimum relative displacement may be a minimum relative angular displacement of at least five degrees with respect to any combination of the X, Y, and Z-axes. Moreover, in such other alternative processes the displayed data 26 may move proportional to the minimum relative angular displacement at every subsequent five degree incremental angle of rotation of the DC device 12. Doing so should reduce shaking of the data 26 displayed on the screen 14. Although the displayed data 26 moves with respect to the screen 14 by an amount proportional to a relative displacement of the DC device 12 in the exemplary process, in alternative processes the displayed data 26 may move with respect to the screen 14 in any manner that facilitates maintaining the relative position between the DC device 12 and the operator to thus maintain the DC device 12 in the optimal position while capturing authentication data of the operator.

In the exemplary process, the captured authentication data is the PIN, voice biometric data, and face biometric data of the operator. In alternative processes the captured authentication data may be the secret answer to a query and iris biometric data. In such alternative processes, the operator recites the secret answer to the query while capturing iris biometric data with the DC device 12.

In yet other alternative processes, any authentication data may be captured that facilitates maintaining the relative position between the DC device 12 and the operator as described herein. For example, an image of the operator's eyes may be captured and movement of the operator's eyes relative to the DC device's field of view may be used to determine whether the DC device 12 is in the optimal position. Moreover, in such alternative processes, the DC device 12 may include multiple cameras that may be used to capture different types of biometric data while an operator uses data displayed thereon. For example, one camera may capture face biometric data while another camera may capture foot biometric data.

Although the displayed data 26 used by the operator is a keypad in the exemplary process, any data 26 may be displayed on the screen 14 that facilitates maintaining the DC device 12 in the optimal position relative to the operator. For example, in alternative processes an article may be the data 26 displayed in the screen 14. In such alternative processes, while an operator uses, or reads, the article data 26 the DC device 12 may shift the text of the article relative to the screen 14 in the same manner as the keypad data 26 is shifted relative to the screen 14 in the exemplary process. Thus, the shifted article acts as a visual cue to the operator that unacceptable authentication data is being captured. The article may also be scrolled between the top 36 and bottom 34 of the screen 14 to act as a visual cue. In such alternative processes, the DC device 12 may simultaneously capture face and iris biometric data. Moreover, while the operator is using the article data 26, the DC device 12 may periodically simultaneously capture face and biometric data of any other characteristic of the operator so that the identity of the individual using the article data 26 can be periodically verified as the operator, and not an imposter. The period may be any duration of time, for example, sixty minutes.

Although the DC device 12 is a portable smart phone in the exemplary process, in alternative processes conducted in accordance with the flowchart 42 illustrated in FIG. 9, the DC device 12 may be a stationary PC equipped with a web cam. Such alternative exemplary processes start 44 with the operator positioning himself relative to the web cam and activating 46 the PC such that at least some of the data 26 is displayed 46 on a screen of the PC. Next, the operator arranges himself in an optimal position 48 relative to the web cam such that the web cam captures a complete facial image of the operator. While the web cam captures an image of the operator 50, the operator may become distracted and inadvertently move in the web cam's field of view. When it is determined 52 that the DC device 12 is not in the optimal position because a partial facial image is within the field of view of the web cam, the PC continues processing by determining the displacement of the current position of the operator relative to the optimal position, and applying the determined relative displacement to the data 26.

While the operator repositions himself 54 relative to the web cam to be in the optimal position, the PC continues by shifting 54 the data 26 on the PC screen until all of the data 26 is displayed. Next, processing continues by conducting operations 56 and 58 as described in the exemplary process.

In each embodiment, the above-described methods for maintaining the relative position between a data capture device and an operator to thus maintain the data capture device in an optimal position, facilitate capturing acceptable authentication data of the operator while using data displayed on a screen of the data capture device. More specifically, after the data capture device is arranged to be in an optimal position relative to an operator of the device, the device captures authentication data of the operator while the operator uses data displayed on a screen of the device. The optimal position is a position of the data capture device in which acceptable authentication data is captured. The device determines whether it is in the optimal position while capturing the authentication data. When the device is in a position different than the optimal position, a displacement of the device relative to the optimal position is determined and applied to the displayed data to shift the displayed data relative to the screen. The shifted data functions as a visual cue to the operator to encourage the operator to move the DC device 12 back to a position substantially the same as the optimal position which results in optimally displaying the data on the screen and capturing acceptable authentication data. As a result, acceptable authentication data is captured that may be used in authentication transactions, and facial recognition and other liveness detection techniques, to verify that an imposter is not providing the authentication data during a remote authentication transaction. Furthermore, the time and costs associated with obtaining authentication data that may be used for generating trustworthy authentication results and detecting the liveness of operators during remote authentication transactions are facilitated to be reduced.

This invention makes practical the simultaneous collection of multiple types of authentication data by enabling the operator to focus on a single task of using the data 26 while maintaining the optimal position of the DC device relative to the operator to enable capture of multiple types of authentication data. Moreover, the processes described herein may be used with a very broad range of authentication data and data displays to facilitate collecting multiple types of authentication data simultaneously while maintaining an optimal position of the DC device relative to the operator.

Exemplary embodiments of methods for maintaining the relative position between a data capture device and an operator using data displayed in the device are described above in detail. The methods are not limited to use with the specific authentication computer systems described herein, but rather, the methods can be utilized independently and separately from other authentication computer components described herein. For example, the methods for maintaining the relative position between data capture devices and operators may be implemented in most computer systems and may be used for a wide range of scenarios, including reading patents on the data capture device that have been downloaded from the internet. Moreover, the invention is not limited to the embodiments of the methods described above in detail. Rather, other variations of the methods may be utilized within the spirit and scope of the claims.

While the invention has been described in terms of various specific embodiments, those skilled in the art will recognize that the invention can be practiced with modification within the spirit and scope of the claims.

1-4. (canceled)

5. An apparatus for capturing authentication data comprising:
a processor;
a memory;
at least one camera; and
a screen, said apparatus being operable to:
determine an optimal apparatus position for capturing face authentication data from an operator, the optimal position being a position in which a complete facial image is captured within a field of view of the at least one camera, and capture at least face authentication data from the operator while the operator uses data displayed on said screen, the displayed data being different than the captured face authentication data; and
when a complete facial image is not captured within the field of view, shift the displayed data relative to said screen to mimic captured face authentication data changes relative to the field of view, the face authentication data changes relative to the field of view caused by moving said apparatus into the optimal position.

6. An apparatus for capturing authentication data in accordance with claim 5, said apparatus being one of the following:
a smart phone;
a tablet computer;
a laptop computer;
a personal computer equipped with a web camera;
a television; and
a gaming console.

7. An apparatus for capturing authentication data in accordance with claim 5, the data displayed on said screen being a keypad or a list of answers with corresponding text-strings.

8. An apparatus for capturing authentication data in accordance with claim 5, said apparatus being further configured to:
determine a displacement of said apparatus in a current position relative to the optimal position; and
shift the data relative to said screen by an amount proportional to the relative displacement.

9. An apparatus for capturing authentication data in accordance with claim 5, said apparatus being further configured to:
shift the displayed data towards a bottom of said screen when said apparatus is rotated counterclockwise about an X-axis; and
shift the displayed data towards a side of said screen when said apparatus is rotated about a Y-axis.

10. (canceled)

11. A computer program recorded on a non-transitory computer-readable recording medium included in a data capture device for maintaining a relative position between the data capture device and an operator, the computer program being comprised of instructions, which when read and executed by the data capture device, cause the data capture device to perform at least the following operations:
determine an optimal data capture device position for capturing face authentication data from an operator, the device having a field of view and a screen, the optimal position being a position in which a complete facial image is captured within the field of view;
capture at least face authentication data from the operator while the operator uses data displayed on the screen, the displayed data being different than the captured face authentication data; and
when a complete facial image is not captured within the field of view, change the displayed data relative to the screen to mimic captured face authentication data changes relative to the device field of view.

12. A computer program in accordance with claim 11 further comprising instructions, which when read and executed by the data capture device, cause the data capture device to shift the data relative to the screen by an amount proportional to a displacement of the data capture device.

13. A computer program in accordance with claim 12 further comprising instructions, which when read and executed by the data capture device, cause the data capture device to shift the data relative to the screen after a minimum relative displacement of the data capture device.

14. (canceled)

15. An apparatus for capturing authentication data in accordance with claim 5 further configured to simultaneously capture secret authentication data, face biometric data, and voice biometric data from the operator.

16. An apparatus for capturing authentication data in accordance with claim 5 further configured to determine whether mouth movements included in the captured authentication data are synchronized with secret authentication data recited by the operator or voice biometric data included in the captured authentication data.

17. An apparatus for capturing authentication data in accordance with claim 5 further configured to capture authentication data while the operator recites text-strings corresponding to characters included in operator secret authentication data.

18. A computer program in accordance with claim 11 further comprising instructions, which when read and executed by the data capture device, cause the data capture device to simultaneously capture secret authentication data, face biometric data, and voice biometric data from the operator.

19. A computer program in accordance with claim 11 further comprising instructions, which when read and executed by the data capture device, cause the data capture device to determine whether mouth movements included in the captured authentication data are synchronized with secret authentication data recited by the operator or voice biometric data included in the captured authentication data.

20. A computer program in accordance with claim 11 further comprising instructions, which when read and executed by the data capture device, cause the data capture device to capture authentication data while the operator recites text-strings corresponding to characters included in operator secret authentication data.
